(19) United States
(12) Patent Application Publication
(10) Pub. No.: US 2013/0255470 A1
(43) Pub. Date: Oct. 3, 2013

(54) Acoustical modification device for musical instruments in the brass family

(71) Applicant: Ryan Palmer, Rockwall, TX (US)

(72) Inventor: Ryan Palmer, Rockwall, TX (US)

(21) Appl. No.: 13/437,862

(22) Filed: Apr. 2, 2012

(51) Int. Cl. G10D 7/10

(52) U.S. Cl. 84/387 R

(57) ABSTRACT

Whereas ordinary unmodified brass instruments have too wide of a pitch center to be played with utmost precision, this invention solves that by manipulating the physics of the path of the sound exiting a bell of a brass instrument, therefor creating tighter pitch centers throughout the range of the instrument to which it is applied. Two layers of cork are cut from a template and glued together with an inner liner of plastic and sealed with a rubberized sealant on the entrance and exit holes of the cone the final product produces. The outside of the exposed cork is then sealed for durability and water resistance. This product is customized for all brass instruments.

### CROSS REFERENCE TO RELATED APPLICATIONS

Not Applicable

### BACKGROUND OF THE INVENTION

Musical instruments in the brass family are not typically in-tune instruments as compared to woodwind family instruments. Brass instruments can be played grossly out of tune. This invention was to solve this issue by limiting the amount of “out of tune” a player is capable of achieving either intentionally or otherwise.

### BRIEF SUMMARY OF THE INVENTION

This invention is a 1 to 2 inch tall conical acoustical device that is to be inserted into the bell of a brass instrument in order to give players of that instrument a smaller target for which to aim. This makes playing the instrument to a high degree of proficiency, much easier.

### BRIEF DESCRIPTION OF THE SEVERAL VIEWS OF THE DRAWING

1/4—Anterior View

FIG. 1—Plastic inner liner

FIG. 2—Cork

FIG. 3—Rubberized sealant

2/4—Exploded View

FIG. 4—Plastic inner liner

FIG. 5—Inner cork piece

FIG. 6—Outer cork piece

FIG. 7—Rubberized sealant

3/4—Posterior View

FIG. 8—Cork

FIG. 9—Rubberized sealant

FIG. 10—Plastic inner liner

4/4—Parts

FIG. 11—Outer cork piece

FIG. 12—Inner cork piece

FIG. 13—Plastic inner liner

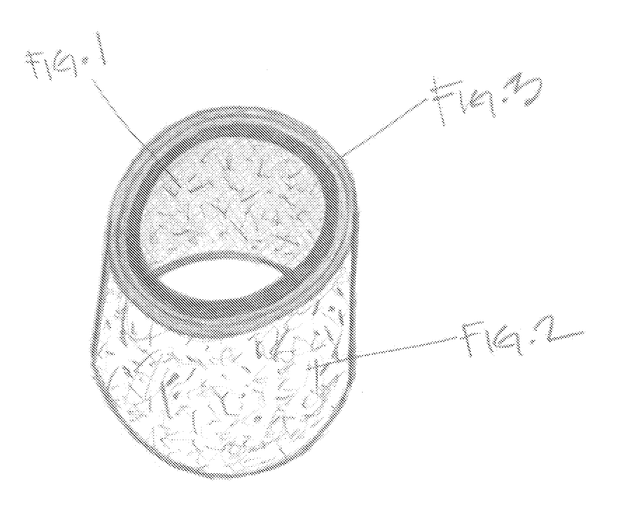

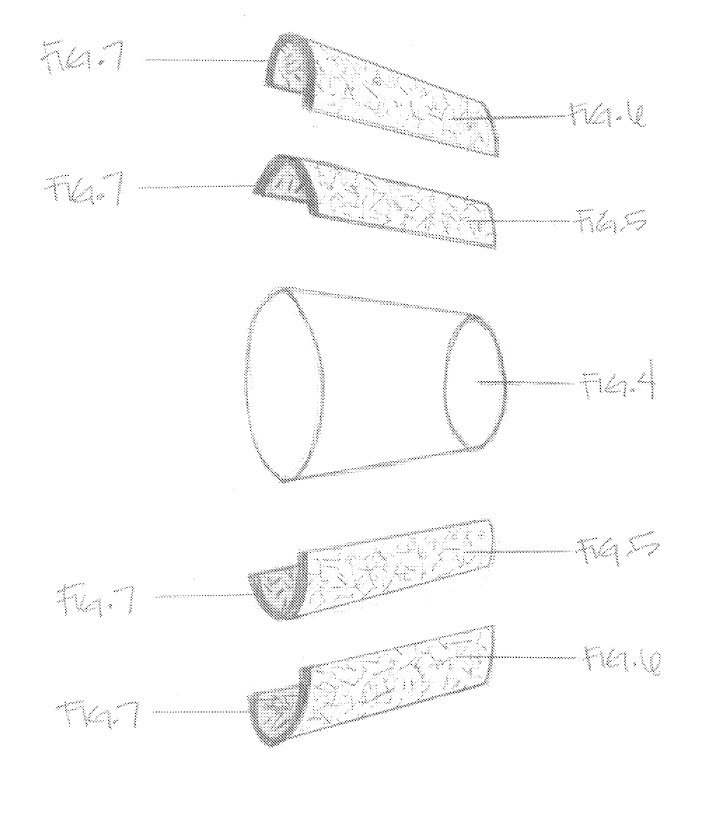

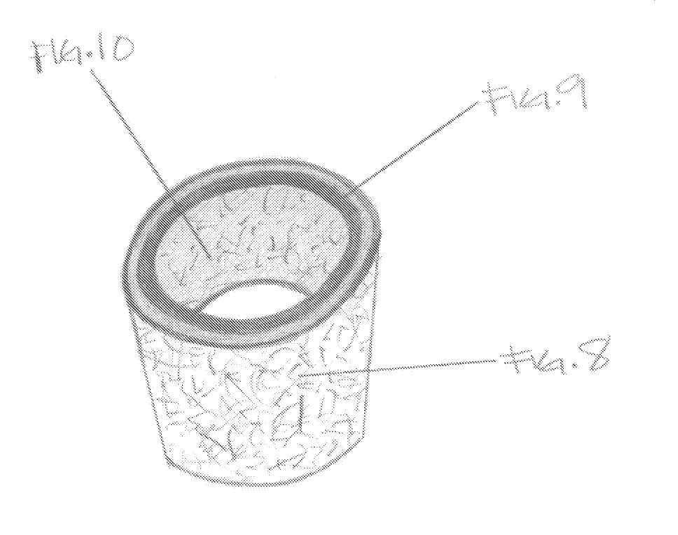

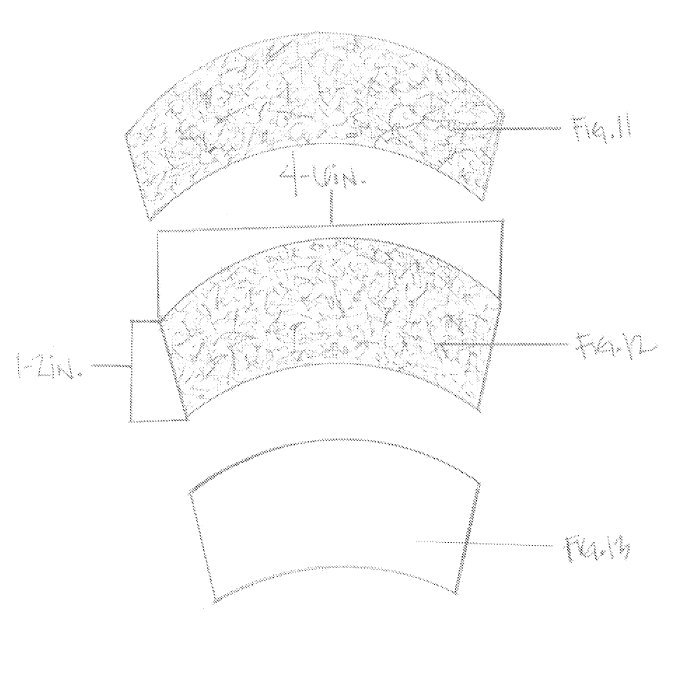

### DETAILED DESCRIPTION OF THE INVENTION

Depending on the size of the bell of the brass instrument, the circumference of the smaller end ranges between 4-6 inches, and the circumference of the larger end ranges between 5-7 inches. It is comprised of three main components; an inner layer of cork, an outer layer of cork, and an inner plastic liner that protects the sound coming from the instrument being absorbed by the cork.

Each of the three main components are to be cut from a sheet of that particular material using either a scalpel, x-acto knife, or scissors.

The three components are glued together, forming a conical shape with two open ends through witch the sound passes in and out.

The ends of the inner cork must first be glued together and allowed to dry. Next the outer cork is glued around the inner cork and allowed to dry. Then the inner plastic liner is glued to the inside of the inner cork and allowed to dry. Then the top opening and bottom opening should be dipped in a rubberized protective coating and allowed to dry. Finally a cork sealant should be applied to the outside of the outer cork layer.

Cork was chosen because it is durable, withstands heat, and can conform to the shape of the bell into which it is inserted.

What is claimed:

1. This acoustical modification device for musical instruments in the brass family makes the brass instrument it is inserted into easier to play by making the pitch center smaller. The pitch center of a brass instrument refers to two components; the maximum pitch variance achievable by the operator of the brass instrument whether higher or lower than the optimum pitch for which the instrument is designed to play, and the maximum allowable variance for which tone remains unaffected.

2. This acoustical modification device for musical instruments in the brass family has a negligible affect on the resonance of the brass instrument for which it is inserted.

3. The acoustical modification device for musical instruments in the brass family is designed to fit snugly into the bell, otherwise known as the exit for the sound coming from said brass instrument.

4. The mechanism of function for the acoustical modification device for musical instruments in the brass family is that the device effectively converts a brass instrument with a wide entry through the bell into a brass instrument with a narrower entry through the bell. This forces the operator of said brass instrument to not be able to play as high or low away from where the instrument was designed to resonate best.

5. By use of the acoustical modification device for musical instruments in the brass family, an operator of the brass instrument can more easily learn how to produce pitches that are conducive to being resonated best by the brass instrument. This has the effect of teaching the operator to produce a better tone quality on the instrument with much reduced physical effort on the part of the operator.

6. The dimensions of the acoustical modification device for musical instruments in the brass family are variable in order to customize the device depending on the specific requirements of different dimensions for the specific instrument for which it is designed.

7. The device is easily installed and/or removed from the instrument.

8. The device is designed to not cause any damage to delicate brass instruments.
